(19) United States
(12) Patent Application Publication
(10) Pub. No.: US 2014/0283941 A1
(43) Pub. Date: Sep. 25, 2014

(54) SEAMLESS, SELF-INSULATED FOAM DUCT AND AN APPARATUS AND METHOD FOR MANUFACTURING THE SAME

(71) Applicant: EVONIK FOAMS, INC., Parsippany, NJ (US)

(72) Inventors: Steven R. Bailey, Magnolia, AR (US); Sharon White Ferguson, Magnolia, AR (US)

(73) Assignee: Evonik Foams, Inc., Parsippany, NJ (US)

(21) Appl. No.: 13/850,115

(22) Filed: Mar. 25, 2013

(51) Int. Cl. F16L 9/00

(52) U.S. Cl. CPC F16L 9/003
USPC 138/149; 29/234; 29/428

(57) ABSTRACT

A seamless self-insulated foam duct made from a single continuous homogenous member of polymeric foam and an apparatus and methods for making such ducts. The homogenous foam member may be transformed to include a plurality of layers such as a densified inner foam layer surrounded by an outer insulating foam layer. The outer insulating foam layer may be partially densified to form a densified outer foam layer. In one embodiment the foam member may be wrapped and bonded to an external layer coating that provides additional protection to the duct. In one embodiment the foam duct is modified to have nestable ends whereby one end of a first foam duct is sized and shape to fit within and snugly engage a compatible end of a second foam duct. The duct may be manufactured by an apparatus capable of implementing a series of cutting and densifying steps that result in custom-sized foam ducts having one or more densified foam layers.

### TECHNICAL FIELD

The technology of the disclosure relates to a seamless self-insulated duct which is manufactured from a single member of polymeric foam. The self-insulated foam duct may be used for ducting applications exposed to an environment having varying ranges of low and high temperatures.

### BACKGROUND

The fabrication, installation, maintenance and repair of ductwork and/or pipework for use in residential and commercial applications such as heating, ventilation and air conditioning (HVAC) systems is an expensive and time-consuming process. Duct work in prior art HVAC systems typically includes a rigid duct that is insulated with an insulating layer that is fitted over the duct. The insulating layer enhances the thermal efficiency of the duct and/or reduces noise associated with movement of air therethrough. Insulation may be made of inorganic materials like fiberglass, calcium silicate, and mineral wool. Inorganic type insulation can also be used for high temperature applications. Further examples of insulation may include polymeric foam materials like polyurethane, polyisocyanurate, polystyrene, polyolefin, and synthetic rubber. Polymeric foam type insulation is commonly used for medium and low temperature applications. In other examples, the insulation may include multiple layers of materials that are adhered together.

In many applications, installing the insulation around the duct includes fitting a pre-fabricated piece of foam insulation having a seam cut along the entire length of the foam insulation so that it can fit around duct. The piece of foam insulation may be adhered to the duct with adhesive and/or tape. The seam can be later sealed with adhesive and/or tape and the like.

Over time, however, due to a combination of normal wear and tear, constant fluctuation in temperatures both inside and outside of the duct, and high coefficient of thermal expansion and following contraction, the pre-fabricated piece of foam insulation would loosen and become uninstalled from the duct. For example, the foam insulation material may compress or shrink when its temperature drops, which may lead to separation between foam insulation and duct. The resulting gap can lead to condensation of water vapor inside the insulation or between the insulation and the pipe, causing serious damage to the insulation and/or the duct. Such events are especially relevant in aerospace applications, such as aircrafts, in which the ductwork is constantly exposed to extreme changes in outer environmental temperatures. Furthermore, the removal and replacement of the insulation is very costly in aircrafts.

In addition to the normal wear and tear as discussed above, variations in duct dimensions can make installation of the insulation difficult. Usually, insulation material is sized to fit a duct's outer diameter (OD). However, due to possible variances in OD and/or incorrectly sized insulation, the fit between the duct may be less than snug and result in a gap left in the insulation, and that gap could be very problematic. The water vapor may result in condensation within the insulation or between the insulation and the duct or pipe. This moisture may cause serious damage to the insulation system and require the system to be replaced after several heating-cooling cycles.

A goal of engineers in the HVAC industry is to develop ductwork that are less expensive, less time consuming to install, and can withstand and tolerate constant fluctuations in temperature, thereby rendering the ductwork longer lasting and requiring less maintenance. An alternative for achieving one or more of these goals is to replace the combination of the traditional HVAC duct or pipe that is wrapped with a separate pre-fabricated piece of foam insulation with a seamless self-insulated foam duct.

One goal of aircraft engineers is to develop lighter components for the reduction of weight and fuel consumption. Alternative materials for aircraft ductwork, for example the replacement of metal ducts with polymeric foam ducts, are one area that could potentially benefit from a seamless self-insulated foam duct.

It is known in the art that a combination of polymer foam and metal may be used to form ducts that are lighter. U.S. Pat. No. 5,210,947, issued on May 18, 1993 to Donnelly teaches a duct comprising a polymeric foam casing containing a helically coiled reinforcing element. An electrical current is passed through the coil thereby melting the foam in contact with the coil. The coil remains embedded in the inner surface and helps to provide form and shape to the duct.

Embodiments disclosed herein can address some or all of the issues mentioned above, including (1) providing a self-insulated polymeric foam duct without the need for a separate insulating material, (2) reducing the risk of the separation of rigid duct from the insulation and separation of multiple layers of insulation materials, (3) reducing the overall weight of ductwork, (4) and addressing thermal contraction of flexible polymeric foam material.

### SUMMARY OF THE DETAILED INVENTION

Embodiments disclosed herein include a seamless self-insulated foam duct. The seamless self-insulated foam duct disclosed herein may be used in the place of a traditional HVAC ductwork, such as a pipe or duct that is wrapped with a separate insulating material. The seamless self-insulated foam duct, which is manufactured from a single piece of continuous, homogenous polymeric foam that has been partially transformed by densification, functions as both the duct or pipe and insulating material. No additional materials need to be wrapped or bonded to the seamless self-insulated foam duct that could become uninstalled over time from normal wear and tear. Embodiments disclosed herein provide seamless self-insulated foam ducts that can address a number of features disclosed in more detail in the detailed description, including but not limited to (1) separation of the elongated member and separate insulation material caused by one or both of expansion and compression of the elongated member and a separate insulation material; (2) reduction of the removal and replacement of damaged separate insulation material; (3) reduction of weight for an HVAC system by replacement of metal pipes or ducts with polymeric foam; and/or (4) customizing the length and/or width of the insulation to adapt to different elongated member sizes and lengths.

The seamless self-insulating foam duct of the present invention comprises at least one continuous, homogenous polymeric foam member that is transformed into multiple foam layers including a densified inner foam layer, an outer insulating foam layer, and in some embodiments, a densified outer foam layer. The foam member is further modified such that a hollow core is formed and extends along the length of the foam member. The foam surrounding the hollow core is densified which forms the densified inner foam layer and provides an air-tight layer between the hollow core and the outside environment in addition to providing acoustic and thermal insulation to the foam duct. More preferably, the densified inner foam layer provides an air-impermeable layer between the hollow core and the outside environment. The foam surrounding the densified inner foam layer, which is not densified, is the outer insulating foam layer. The hollow core of the foam duct allows air or gas to travel therethrough while the densified inner foam layer is air-tight thereby blocking air or gas from escaping out of the walls of the foam duct. The undensified foam of the outer insulating foam layer functions to provide additional acoustic and thermal insulation to the foam duct. Each layer of the foam duct is disposed longitudinally relatively to an axis parallel to air flow through the hollow core. The polymeric foam material may be selected from polyimide foam, polyetherimide foam, polyethylene foam, EVA foam or thermoplastic polyurethane foam.

The dimensions of the foam duct and the various foam layers may vary depending upon the desired characteristics of the duct, including the diameter of the hollow core and the outer diameter of the duct, and the thickness and density of the densified inner foam layer, the outer insulating foam layer and the densified outer foam layer. The density of the various foam layers are one characteristic (thickness being another characteristic) that affects certain properties of the duct, including the rigidity and air-tightness properties of the duct. The density of the densified inner foam layer of the present invention is preferably semi-rigid whereby the duct, when crushed or deformed will return to its original shape while still having the air-tight property. In some instances, the densified inner foam layer of the present invention is rigid whereby the duct, when crushed or deformed will not return to its original shape.

The polymeric foam utilized in the present invention is selected based on certain thermal qualities, including the thermal conductivity value of the foam and the coefficient of thermal expansion. The thermal conductivity values and coefficient of thermal expansion may vary depending upon the desired characteristics of the duct.

One embodiment of the present invention further comprises a densified outer foam layer such that an outer portion of the unmodified foam of the outer insulating foam layer is densified thereby forming the densified outer foam layer. An external layer coating may be disposed around the foam duct and bonded by an adhesive such as glue, solvent or tape. Certain external layer coatings further contribute to the water-repellency property of the foam duct. Other external layer coatings may contribute to the fire resistant property of the foam duct. The external layer coating may be selected from polyether ether ketone (PEEK), polyvinylidene fluoride (PVDF), polyimide, polyphenylsulfone (PPSU), polyethylene terephthalate (PET), paper, coated canvas, polyamides, polysilanes, poly(methyl methacrylate) (PMMA) or combinations thereof.

One embodiment further comprises nestable ends that are sized and shaped to connect end-to-end a first foam duct to a second foam duct. The nestable ends may be formed by cutting, carving or thermoformed so that the nestable ends snugly engage one another. The nestable ends may be further bonded by an adhesive such as glue, solvent or tape.

The apparatus for manufacturing the seamless self-insulating foam duct of the present invention includes an enclosure that functions to secure the foam member without compressing it, a drilling station having a hollow cutting tube that functions to drill a pilot hole through the foam member secured in the enclosure, and a densifying station having a heated probe that functions to densify the densified inner foam layer of the foam member secured in the enclosure.

The enclosure comprises one or more support bars and one or more cross bars configured to form a receptacle shaped and sized to secure the foam member. The enclosure is also configured in such a way as to be connectable with the drilling station and densifying station. The enclosure includes one or more fastening mechanisms disposed thereon in a position that enables their coupling to compatible fastening mechanisms disposed on the drilling station and densifying station. The enclosure may further comprise a hinge mechanism and locking mechanism which function to allow the receptacle to open to receive the foam member, and close and lock to securely retain the foam member in the enclosure.

The drilling station comprises one or more support bars and one or more cross bars, at least one rotating cutting tube, at least one cutting tube guide, and one or more fastening mechanisms disposed thereon. The support bars and cross bars are configured to form a drilling station that is connectable with the enclosure, and functions as a support for the proper positioning of at least one cutting tube guide. When coupled to the enclosure via the compatible fastening mechanisms, the drilling station functions to position and guide the rotating cutting tube through the drilling station and in through the foam member secured in the enclosure.

The densifying station comprises one or more support bars and one or more cross bars, at least one probe, one or more fastening mechanisms disposed thereon. The support bars and cross bars are configured to form the densifying station that is connectable with the enclosure and functions as a support for the proper positioning of the probe. When coupled to the enclosure via the compatible fastening mechanisms, the densifying station functions to position and guide at least one probe through the densifying station and foam member secured in the enclosure. The densifying station may optionally include a cable and pulley that functions to pull the heated probe through the foam member.

The process for manufacturing the seamless self-insulating foam duct of the present invention includes utilizing the apparatus for manufacturing the seamless self-insulating foam duct including securing the foam member in the enclosure apparatus that is, in turn, optionally connected to the drilling and densifying stations in order to carry out the various process steps.

The single continuous homogenous foam member is inserted into the enclosure whereby the foam member is held stationary but is not compressed. The enclosure is then positioned and held in place with the corresponding compatible fastening mechanisms to the densifying station. In the densifying station a probe, sized and shaped to achieve a desired inner diameter of the hollow core, is heated to above the glass transition temperature of the foam member and then inserted into and pushed/pulled through the stationary foam member. As the foam of the foam member is exposed to the probe travelling through the stationary foam member, the probe densifies the foam.

One embodiment further comprises connecting the enclosure to a drilling station prior to densification. In this embodiment the enclosure is positioned and held in place with the corresponding compatible fastening mechanisms to the drilling station. In the drilling station a hollow cutting tube, sized to achieve a desired sized pilot hole, travels through the cutting tube guides of the drilling station and is inserted in the stationary foam member. As the hollow cutting tube travels through the foam member, a pilot hole is created through which the probe of the densifying station may later travel therethrough.

The foam member is then removed from the enclosure and may be held stationary on a standard rotating frame or lathe or a typical apparatus capable of keeping the foam member stationary. The foam member may then be shaped and sized to the desired dimensions of the foam duct, such as the desired outer diameter, by cutting or shaving the un-densified foam with a profile saw or equivalent cutting tool.

Optionally, the densified outer foam layer may be densified by contacting the outer diameter of the foam member with a conventional roller heater or industrial hot plate heated to above the glass transition temperature of the foam member whereby a portion of the outer insulating foam layer is transformed by densification.

Optionally, an external layer coating may be wrapped around the foam duct to further provide additional protection such as water repellency. As the foam duct is rotated on the lathe, the external layer coating is bonded to the outer surface of the foam duct via the application of glue, solvent or tape between the foam duct and external layer coating. Optionally, the external layer coating may be in liquid form whereby the application of such is applied with a brush or other suitable applicator as the foam member rotates on the lathe.

The ends of the foam member are further shaped and sized so that they form nestable ends. A profile saw or equivalent tool is used to carve the ends in such a pattern as to make the ends nestable. The carved ends from separate foam members may be mated together and further bonded together by conventional tape, solvent or glue. The ends of the foam member may be exposed to a conventional roller heater, industrial hot plate or heating element, heated to above the glass transition temperature of the foam member whereby the ends of foam member are densified to form a tapered end. The tapered ends from separate foam members may be connected together and further bonded together by conventional tape, solvent or glue.

Other products and/or methods according to embodiments will be or become apparent to one with skill in the art upon review of the following drawings, and further description. It is intended that all such additional products and/or methods be included within this description, be within the scope of the teachings herein, and be protected by the accompanying claims.

### BRIEF DESCRIPTION OF THE DRAWINGS

The exemplary embodiments, objects, uses, advantages, and novel features are more clearly understood by reference to the following description taken in connection with the accompanying figures wherein:

FIG. 1 illustrates a perspective view of a seamless self-insulated foam duct of the present invention;

FIG. 2 illustrates a perspective view of two seamless self-insulated foam ducts that are connectable by nestable ends.

FIG. 3 illustrates a perspective view of an apparatus for manufacturing a seamless self-insulated foam duct of the present invention.

FIG. 4 illustrates a perspective view of an apparatus for manufacturing a seamless self-insulated foam duct of the present invention.

FIG. 5 illustrates a perspective view of a foam member having multiple pilot holes.

### DETAILED DESCRIPTION OF THE INVENTION

The word “exemplary” is used herein to mean “serving as an example, instance, or illustration.” Any configuration or design described herein as “exemplary” is not necessarily to be construed as preferred or advantageous over other configurations or designs. An example is that the materials used for the exemplary embodiments may be made out of man-made materials, natural materials, and combinations thereof. A further example is that the apparatus or components of the apparatus may be manufactured by machine(s), human(s) and combinations thereof.

Certain embodiments will be described more fully hereinafter with reference to the accompanying drawings, in which exemplary embodiments are shown. These embodiments may, however, be embodied in many different forms and should not be construed as limited to the embodiments set forth herein. These embodiments are provided so that this disclosure will be thorough and complete and will fully convey the scope to those of ordinary skill in the art.

Embodiments disclosed herein include a seamless self-insulated foam duct that may be used in replacement of a conventional HVAC insulated duct, such as a rigid metal or PVC pipe or duct that is insulated with a separate pre-fabricated insulation material such as foam or fiberglass insulation having a seam cut along the entire length of the foam insulation so that it can fit around the pipe or duct. Embodiments disclosed in more detail herein provide seamless self-insulated foam ducts that can address a number of features disclosed in more detail in the detailed description, including but not limited to (1) separation of the elongated member and separate insulation material caused by one or both of expansion and compression of the elongated member and a separate insulation material; (2) reduction of the removal and replacement of damaged separate insulation material; (3) reduction of weight for an HVAC system by replacement of heavy-weighted pipes or ducts (i.e., metal) with polymeric foam; and/or (4) customizing the length and/or width of the insulation to adapt to different elongated member sizes and lengths.

In this regard in certain embodiments disclosed in the detailed description, the seamless self-insulated foam duct is comprised of a single continuous homogenous polymeric foam member. The foam member is modified to comprise a hollow core that centrally extends along the length of the elongated foam member to create a passage way for air or gas, including but not limited to, nitrogen gas, argon gas, helium gas, or other gas that will not react with the foam of the foam duct, to flow therethrough. The hollow core is surrounded by an inner layer of foam that has been densified thereby forming a densified inner layer. The densified inner foam layer is in communication with and surrounded by an outer insulating foam layer in which the foam has not been densified. The inner and outer layers are disposed longitudinally relatively to an axis parallel to air flow. The thickness and density of the outer insulating foam layer will be dictated by the levels of acoustic and/or thermal insulation that are desired or necessary for a particular use.

The seamless self-insulated foam duct replaces both the conventional duct-part and the insulation material. Specifically, the densified inner foam layer functions as the pipe or duct of the traditional HVAC duct and the outer insulating foam layer functions as the insulation material of the traditional HVAC duct. In this regard, the polymeric foam duct is self-insulating because the densified inner foam layer and outer insulating foam layer are made from the same single foam member that has been partially transformed by densification. Therefore, the present invention does not require a separate insulation material to be wrapped around and bonded to the seamless self-insulated foam duct.

The self-insulated foam duct is seamless. In a conventional HVAC duct in which a pre-fabricated piece of foam insulation material is wrapped around the rigid pipe or duct, a seam is cut along the length of the insulation material in order to allow the insulation material to wrap around the pipe. Such a conventional seam is not needed in the present invention because the densified inner foam layer and outer insulating foam layer are part of the same single continuous homogenous foam member that has been partially transformed by densification and therefore does not require a separate insulating material with a seam to wrap around it.

The seamless self-insulated foam duct may be semi-rigid in some embodiments. The densified inner foam layer that is semi-rigid is flexible and crushable such that in the event the semi-rigid foam is flexed, crushed, compressed or bent out of shape, the semi-rigid will revert back to its original shape.

Embodiments disclosed herein include a duct comprising: at least one seamless polymeric foam member having an outer insulating foam layer in communication with a densified inner foam layer surrounding a hollow core that permits flow of air therethrough, the layers disposed longitudinally relatively to an axis parallel to air flow, wherein the foam density of the densified inner foam layer is greater than the outer insulating foam layer.

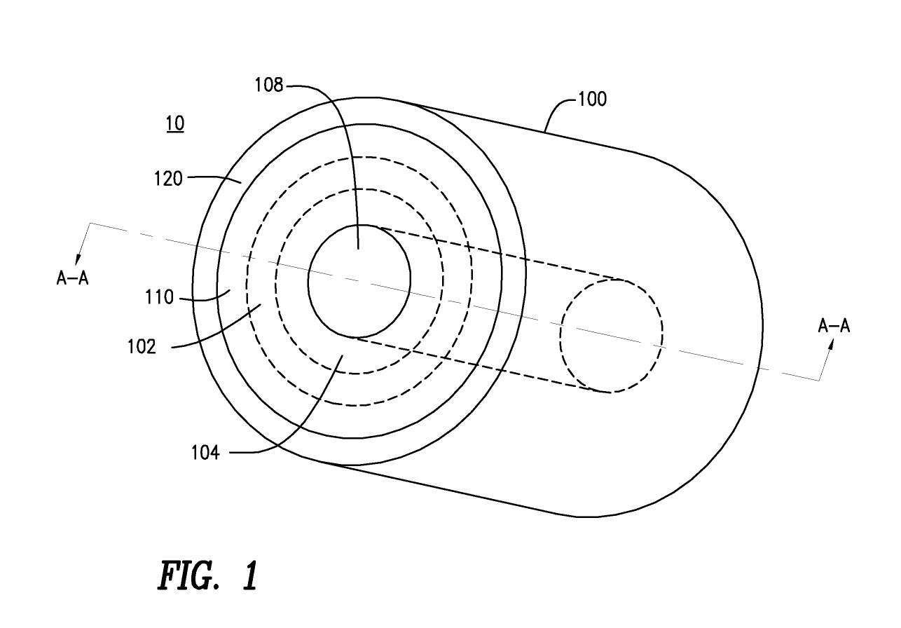

Referring to FIG. 1, there is shown a segment of a seamless self-insulated foam duct 10 in accordance with the present invention. Duct 10 may be a tube comprising a single continuous, homogenous foam member 100 such as a polymeric foam. In one embodiment, the homogenous foam member 100 is transformed to comprise an outer insulating foam layer 102 in communication with a densified inner foam layer 104, the densified inner foam layer 104 surrounding a hollow core 108 sized to allow air or gas to travel therethrough. As depicted, the densified inner foam layer 104 and outer insulating foam layer 102 are disposed longitudinally relatively to an axis A-A, which is parallel to air flow. According to the invention, duct 10 is made from the single continuous, homogenous foam member 100 thereby allowing duct 10 to be seamless.

Preferably the foam member 100 is a polymeric foam material that provides both thermal and acoustic insulation. Examples of polymeric foam include, but are not limited to, polyimide foam, polyetherimide foam, polyethylene foam, or EVA foam or thermoplastic polyurethane foam. In one instance, the polymeric foam selected for use will be temperature dependent such that the duct 10 will be stable and will not change shape by shrinking or expanding, at temperatures between −40° C. and 60° C., having a thermal conductivity of 0.30 Btu·in/hr·ft²·° F. (0.043 W/m° K) or less. One such polymeric foam is SOLIMIDE® polyimide foam manufactured by Evonik Foams, Inc., which has a low coefficient of thermal expansion (i.e., this polyimide foam has little or no shrinkage or expansion with heat and cold exposure).

The diameter of the hollow core 108 may vary dependent upon the volume of airflow desired to travel therethrough. In one embodiment the hollow core 108 is sufficiently sized to allow an airflow of 5000 ft/min at 0.5 lbs/in² (1500 m/min at 6.9 kPa). The hollow core 108 diameter may range from 0.25″ to 30″ (0.635 cm to 76.2 cm). Preferably, the hollow core 108 diameter may range from 0.5″ to 15″ (1.27 cm to 38.10 cm). More preferably, the hollow core 108 diameter may range from 2″ to 10″ (5.08 cm to 25.40 cm). Even more preferably, the hollow core 108 diameter may be 6″ (15.24 cm). Preferably, the diameter of the hollow core 108 is uniform throughout the entire length of the foam member 100.

In one embodiment the densified inner foam layer 104 is air-tight and functions as a barrier between the air travelling through the hollow core 108 and the outside environment. The densified inner foam layer 104 is air-tight, whereby the densified inner foam layer 104 meets specific industry thresholds for maximum allowable leakage rate for air escaping the HVAC duct. For example, in one embodiment the densified inner foam layer 104 has a leakage rate of less than 0.5 ft³/minute/ft² at 0.75 lbs/in² air pressure (0.15 m³/minute/m² at 5.2 KPa air pressure). In another embodiment, the densified inner foam layer 104 is air-impermeable, whereby no air or gas travelling through the hollow core 108 diffuses or otherwise escapes through the densified inner foam layer 104.

Factors that determine the air-tightness and air-impermeability of the duct 10 include both the density of the densified foam and the thickness of the densified inner layer 104. The densified inner foam layer 104 may vary in thickness, however the minimal thickness, for example 0.02″ (0.051 cm), is dependent upon the polymeric foam's characteristic of creating an air-impermeable densified inner foam layer 104. Thickness of the densified inner foam layer 104 may range from 0.02″ to 15″ (0.051 cm to 38.10 cm), preferably from 0.02″ to 10″ (0.051 cm to 25.40 cm), more preferably from 0.1″ to 6″ (0.25 cm to 15.24 cm).

The densification may be illustrated by using the following formula: initial density/final density=final thickness/initial thickness. Densification of the densified inner foam layer 104 is achieved by exposing the polymeric foam to high temperature (i.e., a temperature above the specific foam glass transition temperature) causing the foam to melt, but not degrade or char. For example, when SOLIMIDE® polyimide foam is exposed to temperatures above 260° C., the foam will melt and densify. In one embodiment, the thickness of the densified inner foam layer 104 is 1/16″ (0.159 cm) having a density of 2-3 lb/ft³ (32 to 48 kg/m³). The preferred densities of the densified inner foam layer 104 ranges from 0.7-20 lbs/ft³ (11.2-320 kg/m³), preferably 1.5-5 lbs/ft³ (24-80 kg/m³), and more preferably 2-3 lbs/ft³ (32-48 kg/m³).

In one embodiment the densified inner foam layer 104 may be semi-rigid. The densified inner foam layer 104 that is semi-rigid is flexible and crushable such that in the event the duct 10 is flexed, crushed, compressed or bent out of shape, the duct 10 will revert back to its original shape. It is preferable that the semi-rigid densified inner foam layer 104 is also air-impermeable. In this embodiment, the preferable thickness is 0.02″ (0.051 cm) densified foam from an original thickness of 0.5″ (1.27 cm) of undensified foam to obtain 0 air flow at 1″ H₂O vacuum (0.25 kPa vacuum).

In another embodiment the inner foam layer 104 may be rigid. In certain HVAC applications, there may be a desire to have a rigid duct 10. In one embodiment of the invention, the thickness of the densified inner foam layer 104 may be increased such that the densified inner foam layer 104 is rigid in structure. For example, as the thickness and density of the densified inner foam layer 104 increases to greater than ½″ (1.27 cm) and 5 lb/ft³ (80 kg/m³), the densified inner foam layer 104 becomes rigid in structure whereby the duct 10 cannot be crushed or bent out of shape.

In one embodiment the outer diameter of the duct 10 may vary in size and shape and in some instances are limited by the size of the structure or area in which the foam duct 10 is to be installed. Reduction of noise resulting from air or gas travelling through the duct 10 is affected by the thickness of the outer insulating foam layer 102, and to a lesser degree, the densified inner foam layer 104. The thermal insulation capabilities of the duct 10 are affected by the thickness of the outer insulating foam layer 102, and to a lesser degree, the densified inner foam layer 104. Hence, the outer diameter of the duct 10 will be dictated by the desired characteristics for the duct 10. In one embodiment, the outer insulating foam layer 102 thickness ranges from 0.1″ to 30″ (0.25 cm to 76.2 cm). Preferably, the outer insulating foam layer 102 thickness ranges from 0.2″ to 20″ (0.508 cm to 50.8 cm). In one embodiment, the outer insulating foam layer 102 thickness of 0.25″ (0.635 cm) is preferred. More preferably from 0.2″ to 10″ (0.508 cm to 25.40 cm). In one embodiment, the density of the outer insulating foam layer 102 is less than the density of the densified inner foam layer 104. In another embodiment the density of the outer insulating foam layer 102 is less than 1-3 lb/ft³ (16-48 kg/m³). In a preferred embodiment, the density of the outer insulating foam layer 102 of the present invention is 0.35 lb/ft³ (5.6 kg/m³). The duct 10 may be customized in shape in such a way as to meet the specific needs of its application. It is contemplated the outer insulating foam layer 102 may be cut or carved into various shapes such as but not limited to, round, hexagonal, octagonal, oval, triangular or other shape suitable for an immediate need.

The thermal conductivity value (Tk) may vary depending upon the application of the duct 10. Thermal conductivity is a measure of the ability of a material to conduct heat. The lower the Tk, the worse a conductor, hence, the better an insulator the material is. This property is especially important in ventilation ducts where the purpose is to supply air that is a different temperature than its surroundings. The higher the Tk of the duct, the more change in the temperature of the air inside the duct, which results in less efficiency. The preferred maximum thermal conductivity for duct insulation in aircraft is 0.9 Btu·in/hr·ft²·° F. (0.130 W/m° K). The typical preferred Tk for HVAC ducts in passenger rail cars is 0.32 Btu·in/hr·ft²·° F. (0.046 W/m° K). The HVAC industry typically indicates R-Value, which is the inverse of the thermal conductivity at 1″ (2.54 cm) thickness. An R-Value of 4.2 for 1″ (2.54 cm) duct liner is the current standard in the industry. Commercial building energy codes dictate R-Value requirements depending on where the ducts are in a building (i.e., ducts on the roof of a building structure are required to be insulated with a R-Value of R-8 insulation, however, some local codes in warmer climates require a R-Value of R-10), ducts in unconditioned spaces have to meet a minimum of R-5 or R-6 depending on where they are located. In one embodiment the preferred thermal conductivity value is equal to or less than 0.90 Btu·in/hr·ft²·° F. (0.130 W/m° K). In one embodiment the preferred thermal conductivity value is equal to or less than 0.40 Btu·in/hr·ft²·° F. (0.058 W/m° K). In one embodiment the preferred thermal conductivity value is equal to or less than 0.30 Btu·in/hr·ft²·° F. (0.043 W/m° K). In one embodiment the preferred thermal conductivity value is equal to or less than 0.25 Btu·in/hr·ft²·° F. (0.036 W/m° K). In one embodiment, the preferred thermal conductivity value is 0.32 Btu·in/hr·ft²·° F. (0.046 W/m° K). In one embodiment the preferred thermal conductivity value ranges from 0.30 to 0.90 Btu·in/hr·ft²·° F. (0.043 to 0.130 W/m° K).

In one embodiment the self-insulating foam duct 10 has a very low coefficient of thermal expansion. The coefficient of thermal expansion (CTE) is a measure of the change in the dimensions of a material per change in temperature. A duct with a high CTE is problematic as high temperature fluctuations may cause the duct to deform resulting in loss of efficiency, damage or destruction of the duct. Closed cell foams tend to have higher CTEs than open cells due to the impact of temperature fluctuations on the volume of the gas trapped inside the cells. Conversely, polymers with higher glass transition temperatures tend to have lower CTEs as the structure of the polymer is stable at lower temperature. Preferably, the self-insulating foam duct 10 has a linear coefficient of thermal expansion of equal to or less than 10×10⁻⁵ m/m° C. (5.5×10⁻⁵ in/in° F.).

In another embodiment, the undensified foam of the outer insulating foam layer 102 is transformed by densification. In certain applications of the seamless self-insulated foam duct 10, densification of the foam member 100 may be desired. In such applications, it is contemplated that both the densified inner foam layer 104 and the outer foam layer 102 are densified to form a densified seamless self-insulated foam duct 10.

In another embodiment, a portion of the foam forming the outer diameter of the outer insulating foam layer 102 may be densified to form a densified outer foam layer 110 such that the density of the densified outer foam layer 110 is greater than the density of the outer insulating foam layer 102. The density and thickness of the densified outer foam layer 110 will vary dependent upon the amount of undensified foam from the outer insulating foam layer 102 that is then densified. In one embodiment, the density of the densified outer foam layer 110 is 0.7-5 lbs/ft³ (11.2-80 kg/m³). It is contemplated that the minimum thickness of the densified outer foam layer 110 would be sufficient to create a water repellent layer, while still being semi-rigid and providing the desired thermal and acoustic insulation. Thickness of the densified outer foam layer 110 may range from 0.02″ to 15″ (0.051 cm to 38.10 cm), preferably from 0.02″ to 10″ (0.051 cm to 25.40 cm), more preferably from 0.1″ to 6″ (0.25 cm to 15.24 cm). In one embodiment, the duct 10 with an outer insulating foam layer 102 thickness of 0.75″ (1.905 cm) is reduced to a thickness of ⅜″ (0.953 cm) (by densification via application of heat (i.e., a temperature above the glass transition temperature of the foam member 100) and pressure to form the densified outer foam layer 110. In another embodiment, the duct 10 with an outer insulating foam layer 102 thickness of 1″ (2.54 cm) is reduced to a thickness of 0.75″ (1.905 cm) by densification via application of heat (i.e., a temperature above the glass transition temperature of the foam member 100) and pressure.

According to one embodiment of the invention, an external layer coating 120 may be wrapped around and bonded to the outer diameter surface of the duct 10. It is contemplated that the external layer coating 120 functions to provide a protective coating around the duct 10 and in some instances provides a water-repellent barrier between the duct 10 and the outside environment. In other instances, the external layer coating may contribute to the fire resistant property of the foam duct 10. For example, The external layer coating 120 may be a film with or without reinforcement or may be metalized, and may be selected from various materials such as, but not limited to, polyether ether ketone (PEEK), polyvinylidene fluoride (PVDF), polyimide, polyphenylsulfone (PPSU), polyethylene terephthalate (PET), paper, coated canvas, polyamides, polysilanes, poly(methyl methacrylate) (PMMA) or combinations thereof. In one embodiment, the external layer coating 120 is bonded to the outer diameter of the duct 10 with adhesive, solvent or tape. In other embodiments, the external layer coating 120 may be in a liquid form and thereby sprayed on or applied with a brush or other suitable applicator.

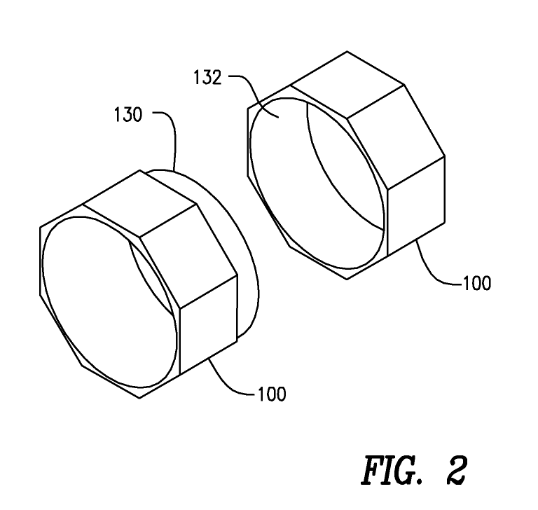

In one embodiment, as depicted in FIG. 2, two foam members 100 may be connected end-to-end wherein the foam members 100 further comprise compatible nestable ends 130 and 132 which, when connected together form an air-tight, and in some instances an air-impermeable seal. Nestable refers to the modification, by carving, thermoforming or other conventional method, of the ends 130 and 132 of the foam members 100 such that one end may fit snugly within the other end. In this embodiment nestable end 130 of a first foam member 100 may be tapered, carved or shaped such that the nestable end 130 is sufficiently reduced in outer diameter so that it may be received by and snugly engage a compatible unmodified, and in some instances tapered, carved or shaped nestable end 132 of a second foam member 100. In another embodiment, the nestable end 130 may be thermoformed so that it may be received by and snugly engage the compatible nestable end 132 of a second foam member 100. The nestable ends 130 and 132 may be bonded together by adhesive, solvent, tape or a combination thereof to provide additional security and air-tightness or air-impermeability.

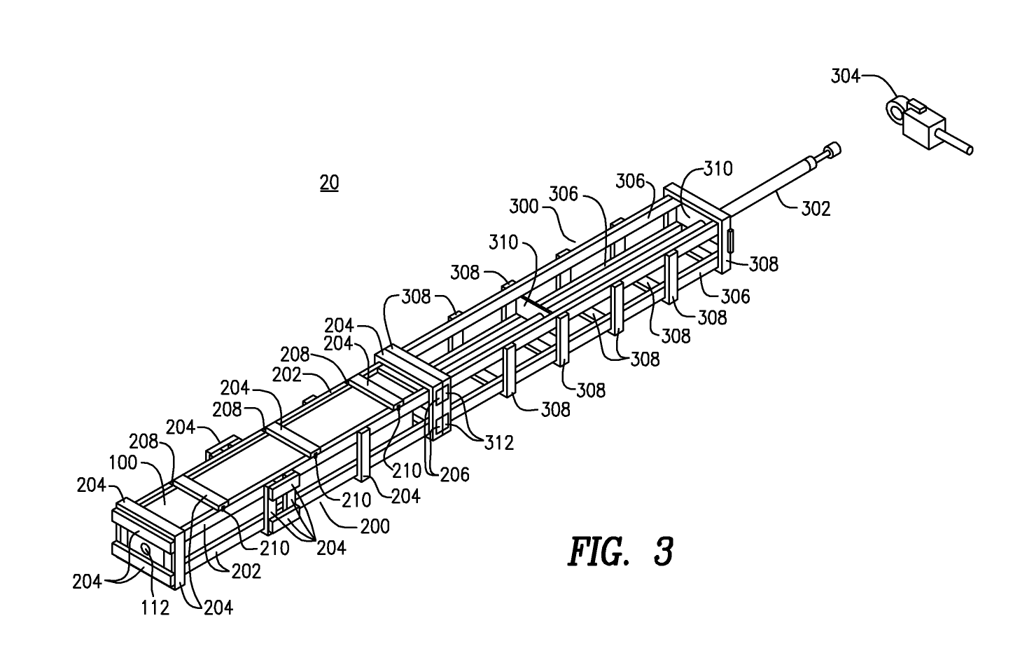

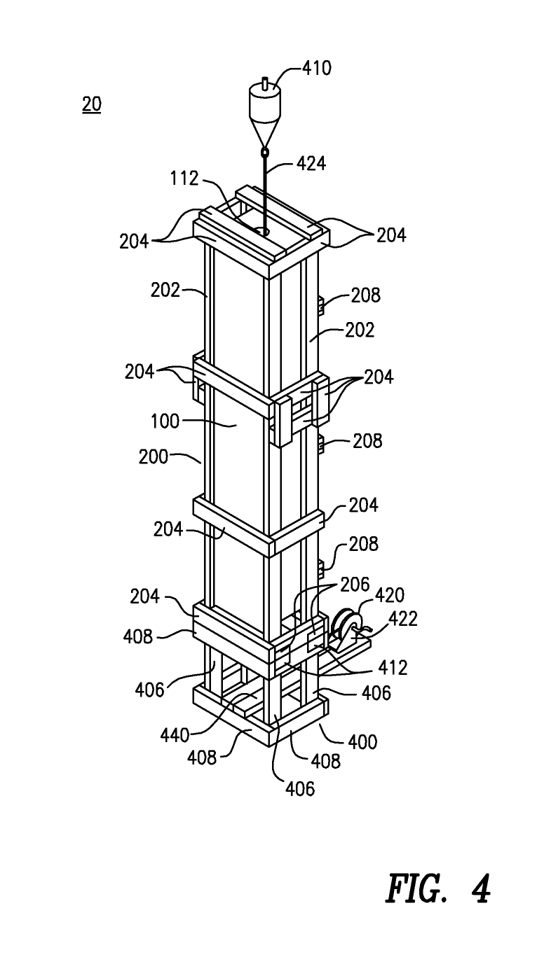

In one embodiment, the manufacture of the seamless self-insulated foam duct 10 may be accomplished by use of an apparatus 20 as illustrated in FIGS. 3 and 4. Embodiments disclosed herein include an apparatus for manufacturing a seamless duct, said duct having a polymeric foam member having a first outer insulating layer in communication with a densified inner layer surrounding a hollow core, the apparatus comprising: an enclosure having one or more support bars and cross bars forming a receptacle to secure the foam member, and one or more fastening mechanisms, a drilling station having at least one rotating cutting tube, one or more support bars and cross bars, at least one rotating cutting tube guide and one or more fastening mechanisms, a densifying station having at least one probe, one or more support bars and cross bars, a pulley and one or more fastening mechanisms, wherein the enclosure is connectable to the drilling station and densifying station. As shown, the apparatus 20 comprises an enclosure 200, a drilling station 300, a densifying station 400, or a combination thereof.

Referring to FIG. 3, the apparatus 20 comprises an enclosure 200 that is sized to receive and secure the foam member 100. The enclosure 200 may have one or more support bars 202 and cross bars 204 configured in such a manner as to form a receptacle of enclosure 200 that is sized to receive and hold the foam member 100 snugly within enclosure 200 yet not compressed. The enclosure 200 may be fitted with one or more hinges 208 and one or more locks 210, the hinges 208 and locks 210 disposed on the enclosure 200 so as to allow certain cross bars 204 and/or support bars 202 to open and close thereby allowing the foam member 100 to be inserted and locked in the enclosure 200. Disposed on one end of the enclosure 200 are one or more fastening mechanisms 206 that are compatible with the fastening mechanisms of the various process stations, and function to properly position and hold in place the enclosure 200 to the various process stations (as described below). It is contemplated the enclosure 200 may be made from various materials that are resistant to heat, bending or warping, such as but not limited to wood, metal, plastic or a combination thereof.

In one embodiment, as depicted in FIG. 3, the enclosure 200 is connected to a drilling station 300. The drilling station 300 provides a sturdy support which enables a rotating cutting tube 302 controlled by a motor 304 to cut out a pilot hole 112 running along the length of the foam member 100. The rotating cutting tube 302 is a hollow long rod-like member having at one end a cutting blade (not shown), and at the opposing end a customized tapered segment capable of being attached to the motor 304. The rotating cutting tube 302 may be longer than the foam member 100. It is contemplated the rotating cutting tube 302 may be made from various materials such as but not limited to metal, ceramic or plastic. The rotating cutting tube 302 may vary in diameter, such that the diameter of the cutting tube 302 may be selected dependent upon the pilot hole 112 diameter desired for the duct 10. As shown, the drilling station 300 contains one or more support bars 306 and cross bars 308 connected in such a manner as to form a drilling station 300 that is connectable with the enclosure 200 and functions as a support for the proper positioning of one or more removable guides 310 that are sized and shaped to receive, position and guide the rotating cutting tube 302 through the drilling station 300 and into the foam member 100 situated with the enclosure 200. One or more fastening mechanisms 312 are attached to the drilling station 300 and disposed thereon such that they receive and connect to the compatible fastening mechanism 206 of the enclosure 200. Various methods of cutting the pilot hole 112 may be implemented by using the apparatus 20 as depicted herein. It is contemplated that either the motor 304 and cutting tube 302 remain stationary as the locked enclosure 200 and drilling station 300 are moved along the length of the rotating cutting tube 302, or the motor 304 and cutting tube 302 are inserted through a stationary enclosure 200 and drilling station 300.

It is contemplated that the manufacture of the duct 10 may be adapted for use on the industrial scale by securing the foam member 100 into a frame (not shown), and using a conventional industrial drill press to cut the pilot hole. The drill press may be replaced with a conventional hydraulic ram connected with a probe situated at the end. As the probe, heated to a specific temperature (such as a temperature above the glass transition temperature of the foam member 100), is pushed through the pilot hole by the hydraulic ram, densification of the inner layer occurs.

As depicted in FIG. 4, the enclosure 200 is fastened to a densifying station 400. The densifying station 400 provides a sturdy support which positions and enables at least one probe 410 to travel through the foam member 100, and optionally the pilot hole 112, if present. As shown, the densifying station 400 contains one or more support bars 406 and cross bars 408 connected in such a manner as to form the densifying station 400 that is connectable with the enclosure 200 and functions as a support for the proper positioning of the probe 410. One or more fastening mechanisms 412 are attached to the densifying station 400 and disposed thereon such that they receive and connect to the compatible fastening mechanism 206 of the enclosure 200. When coupled to the enclosure 200 the densifying station 400 functions to position and guide at least one probe 410 through the foam member 100 secured in the enclosure 200.

When the probe 410 is heated to a specific temperature (i.e., to a temperature above the glass transition temperature for the foam member 100), the heated probe 410 is capable of densifying the foam of the foam member 100 that is exposed to the heated probe 410 as it travels therethrough. In one embodiment, the hollow core 108 and the densified inner foam layer 104 are formed as the heated probe 410 travels through the foam member 100 such that the densifying foam of the foam member 100 creates an opening of a certain diameter (directly related to the size of the probe 410) becoming the hollow core 108 and the densified foam resulting from exposure to the heated probe 410 is the densified inner foam layer 104. As shown, the densifying station 400 and enclosure 200 are configured so that the foam member 100 is positioned vertically whereby the heated probe 410 enters the foam member 100 from the top and gravitational forces act upon the probe 410 to travel downward through the foam member 100, densifying the foam as it travels therethrough.

In one embodiment in which a pilot hole 112 has been created, the hollow core 108 and the densified inner foam layer 104 are formed as the heated probe 410 travels through the pilot hole 112 such that the pilot hole 112 expands in diameter becoming the hollow core 108 and the densified foam resulting from exposure to the heated probe 410 is the densified inner foam layer 104.

In one embodiment, to move the probe 410 through the pilot hole 112 of the foam member 100, the densifying station 400 may comprise a pulley system 420. The pulley system 420 may comprise a hand-operated or motor-driven winch 422 that drives cable(s) 424 connecting to the probe 410. The hand-operated or motor-driven pulley 422 may be mounted on a built-in platform 440 of the densifying station 400.

It is contemplated that the probe 410 may be made from a material that can be heated to and maintain a specific temperature, such as but not limited to ceramic, metal or a combination thereof. The probe 410 may vary in length, for example a probe 410 having a short plug-like length or a long rod-like length. It is contemplated the length of the probe 410 may range from 1″ (2.54 cm) to a length longer than the foam member 100. The probe 410 may vary in diameter, such that the diameter of the probe 410 would be selected dependent upon the hollow core 108 diameter desired for the duct 10. The probe 410 may vary in shape, for example, the tip of the probe 410 may be blunt or tapered. In one embodiment it is contemplated that the probe 410 may further include a conventional electrical or heating coil (not shown) for constant temperature as the probe 410 is traveling through the foam member 100. It is further contemplated that the densifying station 400 may comprise a plurality of probes 410, each of the probes 410 oriented inline to one another either independently or connected by the cable(s) 424 so that they travel through the foam member 100 one after the other.

In some embodiments, the pilot hole 112 is not desired, and therefore, the drilling station 300 not utilized. For example, a suitably sized heated probe 410 travelling through the foam member 100 absent a pilot hole 112 would sufficiently form the desired diameter of the hollow core 108 of the duct 10. As the heated probe 410 travels through the foam member 100, the foam densifies thereby forming the hollow core 108 in the pathway of the heated probe 410. This embodiment is particularly useful for manufacturing foam ducts having a small hollow core 108.

According to the present invention, the process to manufacture the seamless self-insulated foam duct 10 includes the utilization of the apparatus 20 and includes various steps to transform the single homogenous foam member 100 into the duct 10 having a hollow core 108 and two or more layers. Embodiments disclosed herein include a method for manufacturing a seamless duct, said duct having a polymeric foam member having an outer insulating foam layer in communication with a densified inner foam layer surrounding a hollow core, comprising the steps of: (a) securing the foam member; (b) heating a probe to a temperature above the glass transition temperature of the foam member; (c) densifying the inner foam layer by moving the heated probe in one end of the foam member through and out of the opposing end of the foam member thermoforming the densified inner foam layer and the hollow core; and (d) shaping the outer insulating layer.

The process for manufacturing the seamless self-insulating foam duct 10 of the present invention includes securing the foam member 100 in the enclosure 200. Once the foam member 100 is secured, the enclosure 200 may be connected to the drilling station 300 or the densifying stations 400 in order to carry out the various process steps.

The single continuous homogenous foam member 100 is inserted into the enclosure 200 whereby the foam member 100 is held stationary but is not compressed. The enclosure 200 is then positioned and locked in place with the fastening mechanisms 206 and 412 to the densifying station 400 so that the foam member 100 is vertically situated end on end. In the densifying station 400 a probe 410, that is sized and shaped to achieve a desired diameter of the hollow core 108, and has been heated to above the glass transition temperature of the foam member 100, is inserted in the stationary foam member 100. The probe 410 travels downwards through the foam member 100 due to gravitational forces. As the foam of the foam member 100 is exposed to the heated probe 410 as it travels through the stationary foam member 100, the probe 410 densifies the foam, thereby transforming a portion of the homogenous foam member 100 into the densified inner foam layer 104. (i.e., the portion of the homogenous foam member 100 in communication with the hollow core 108)

One embodiment of the present invention also comprises connecting the enclosure 200 to a drilling station 300 prior to densifying station 400. In this embodiment the enclosure 200 is positioned and locked in place with the corresponding fastening mechanisms 206 and 312 to the drilling station 300. In the drilling station 300 a rotating cutting tube 302, sized to cut-out the desired sized pilot hole 112, is inserted in the stationary foam member 100. As the rotating cutting tube 302 travels through the foam member 100, the pilot hole 112 is formed through which the probe 410, connected to the cable 424, which was previously threaded through the pilot hole 112, may later travel therethrough via the pulley system 420.

The foam member 100 that has been transformed to include the densified inner foam layer 104 and hollow core 108 is removed from the enclosure 200 and is placed on a conventional rotating frame or lathe or an apparatus capable of keeping the foam member 100 stationary. The foam member 100 may then be shaped and sized to the desired dimensions (i.e., the desired outer diameter) by cutting or shaving the foam member 100 with a profile saw or equivalent cutting tool. The remaining undensified foam is the outer insulating foam layer 102.

If the densified outer foam layer 110 is desired, an externally located portion of the outer insulating foam layer 102 is transformed by densification to form the densified outer foam layer 110. This layer may be densified by contacting the outer diameter of the foam member 100 with a conventional roller heater or industrial hot plate heated to above the glass transition temperature of the foam member 100. As the foam member 100 rotates on the conventional rotating lathe, the outer diameter of the foam member 100 becomes densified.

The foam member 100, still rotating on the conventional rotating frame, may be wrapped with the external layer coating 120. The external layer coating 120 may be bonded to the foam member 100 by having an adhesive or a solvent applied to the underside of the external layer coating 120 by an adhesive or a solvent applicator (not shown) and wrapped around the rotating foam member 100.

The ends 130 and 132 of the foam member are further shaped and sized so that they snugly connect together. A profile saw or equivalent cutting tool is used to carve the ends 130 and 132 in such a pattern as to make the ends nestable. The carved ends 130 and 132 from separate foam members 100 may be mated together and further bonded together by conventional tape or glue. The ends 130 and 132 of the foam member 100 may be exposed to a conventional roller heater, industrial hot plate or heating element, heated to above the glass transition temperature of the foam member 100 whereby the ends 130 and 132 of foam member 100 are densified to form a tapered shape. The tapered ends 130 and 132 from separate foam members 100 may be connected together and further bonded together by conventional tape or glue.

For example, a block of SOLIMIDE® polyimide foam member 100 having a dimension of 14″×14″×6′ (35.56 cm×35.56 cm×182.88 cm) may be placed in a suitably sized and shaped enclosure 200. The enclosure 200 is made such that the foam member 100 is standing end over end. The enclosure 200 is connected to the drilling station 300. A 3″ (7.62 cm) diameter pilot hole 112 is drilled through the foam member 100. The enclosure 200 is then connected to the densifying station 400. The heated probe 410, in this instance having a 6″ (15.24 cm) diameter, a tapered and pointed end and a length of 12″ (30.48 cm) and heated to 260° C., which is attached to the cable 424, that has been previously threaded through the pilot hole 112, and driven by the pulley system 420, is pulled through the pilot hole 112 densifying the foam as it passes therethrough, forming the densified inner foam layer 104. The foam member 100 is then removed from the enclosure 200 and the outer insulating foam layer 102 cut with a profile saw so that the outer diameter of the duct 10 is 6⅜″ (16.192 cm). In another embodiment, an external layer coating 120 is wrapped around and bonded to the outer surface of the duct 10.

In another embodiment, an additional foam densifying step is contemplated. The same procedure is followed above, except the outer diameter of the duct 10 is cut to 6¾″ (17.145 cm) with the profile saw. Thereafter, the hollow core 108 of the duct 10 may be secured on a conventional mechanical rotating frame, or optionally a lathe. As the duct 10 rotates, a conventional roller heater (for example, but not limited by, the Thermalon RI200 by American Roller Company), or a conventional industrial hot plate (for example, but not limited by, a custom Vecstar industrial hot plate) which is heated to 260° C. is brought into contact with the outer foam layer 102 thereby densifying a portion of the outer insulating foam layer 102 forming the outer densified foam layer 110. In this embodiment, the final outer diameter of the duct 10 is 6⅜″ (16.192 cm).

It is contemplated that similar methods may be implemented to any suitable polymeric foam. The specific molding temperature will vary depending upon the polymeric foam utilized.

In another embodiment, the duct 10 may be curved or other shape. For example, the support bars 202 and cross bars 204 of the enclosures 200 may be configured to enclose various curved or shaped foam members 100. The foam member 100 may be pre-cut to engage the receptacle of enclosure 200 such that the foam member 100 will not be compressed in the enclosure 200. A heated rod member (not shown) heated to a specific temperature (such as heated to 260° C. or a suitable temperature above the glass transition temperature of the foam member 100) may be sized and shaped to match the shape of the enclosure 200. As the heated rod member travels through the foam member 100, densification of the foam member 100 occurs.

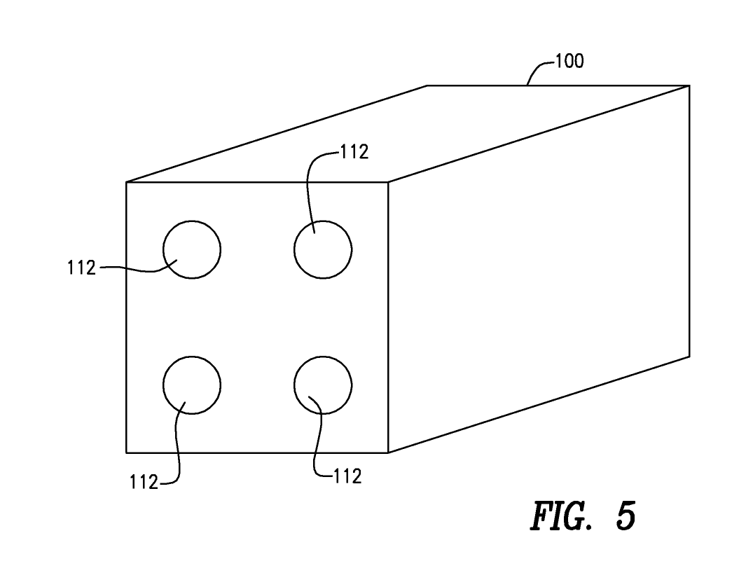

In another embodiment, as depicted in FIG. 5, a single piece of foam member 100 may generate one or more ducts 10. The foam member 100 may be sized and the enclosure 200, drilling station 300 and densifying station 400 modified to support the positioning of multiple pilot holes 112 to be drilled through the foam member 100. After the densification step, the foam member 100 may be removed from the enclosure 200 and further cut to separate single ducts 10 or optionally, a duct 10 having at least two hollow cores 108.

In another embodiment, it is contemplated that the drilling of the pilot hole 112 and subsequent inner diameter densification of the foam member 100 may be accomplished at the same time. In this embodiment, a suitably sized heated probe 410 to achieve the desired inner diameter of the hollow core 108 may be forced through a solid block of foam. Optionally, the rotating cutting tube 302 may be heated to a specific temperature (such as heated to 260° C. or a suitable temperature above the glass transition temperature of the foam member 100) thereby densifying the foam member 100 as the cutting tube 302 travels therethrough.

In describing the invention, certain embodiments have been used to illustrate the invention, the practice thereof, and the methods of making such. However, the invention is not limited to these specific embodiments as other embodiments and modifications within the spirit of the invention will readily occur to those skilled in the art on reading the specification. Thus, the invention is not intended to be limited to the specific embodiments disclosed, but is to be limited only by the claims appended hereto.

What is claimed is:

1. A duct comprising:
at least one seamless polymeric foam member having an outer insulating foam layer in communication with a densified inner foam layer surrounding a hollow core that permits flow of air therethrough, the layers disposed longitudinally relatively to an axis parallel to air flow,
wherein the foam density of the densified inner foam layer is greater than the outer insulating foam layer.

2. The duct according to claim 1, wherein the densified inner foam layer is air-impermeable.

3. The duct according to claim 1, wherein the foam member further comprises a densified outer foam layer in communication with the outer insulating foam layer, and wherein the foam density of the densified outer foam layer is greater than the outer insulating foam layer.

4. The duct according to claim 1, wherein the densified inner foam layer has a density of 0.7-20 lbs/ft³.

5. The duct according to claim 3, wherein the densified outer foam layer has a density of 0.7-5 lbs/ft³.

6. The duct according to claim 1, wherein the foam member is selected from polyimide foam, polyetherimide foam, polyethylene foam, EVA foam or thermoplastic polyurethane foam.

7. The duct according to claim 1, wherein the hollow core of the foam member ranges in size from about 0.25″ to 30″ in diameter.

8. The duct according to claim 1, wherein the densified inner foam layer is semi-rigid.

9. The duct according to claim 1, wherein the densified inner foam layer is rigid.

10. The duct according to claim 1, wherein the densified inner foam layer ranges in thickness from about 0.02″ to 15″.

11. The duct according to claim 1, wherein the outer insulating foam layer ranges in thickness from about 0.1″ to 30″.

12. The duct according to claim 1, wherein the duct has a thermal conductivity value is equal to or less than 0.90 Btu·in/hr·ft²·° F.

13. The duct according to claim 1, wherein the duct has a linear coefficient of thermal expansion of equal to or less than 10×10⁻⁵ m/m° C.

14. The duct according to claim 1, wherein the foam member further comprises an external layer coating disposed on the outer surface of the duct.

15. The duct according to claim 14, wherein the external layer coating is selected from polyether ether ketone (PEEK), polyvinylidene fluoride (PVDF), polyimide, polyphenylsulfone (PPSU), polyethylene terephthalate (PET), paper, coated canvas, polyamides, polysilanes, poly(methyl methacrylate) (PMMA) or combinations thereof.

16. The duct according to claim 1, wherein the foam members further comprise nestable ends.

17. A duct comprising:
at least one seamless polymeric foam member having an outer insulating foam layer in communication with a densified inner foam layer surrounding a hollow core that permits flow of air therethrough, the layers disposed longitudinally relatively to an axis parallel to air flow,
wherein the duct has a thermal conductivity value 0.32 Btu·in/hr·ft²·° F. and a linear coefficient of thermal expansion of equal to or less than 10×10⁻⁵ m/m° C.,
and wherein the foam density of the densified inner foam layer is 2-3 lb/ft³ and the foam density of the outer insulating foam layer is less than the foam density of the densified inner foam layer.

18. An apparatus for manufacturing a seamless duct, said duct having a polymeric foam member having a first outer insulating layer in communication with a densified inner layer surrounding a hollow core, the apparatus comprising:
an enclosure having one or more support bars and cross bars forming a receptacle to secure the foam member, and one or more fastening mechanisms,
a drilling station having at least one rotating cutting tube, one or more support bars and cross bars, at least one rotating cutting tube guide and one or more fastening mechanisms,
a densifying station having at least one probe, one or more support bars and cross bars, a pulley and one or more fastening mechanisms,
wherein the enclosure is connectable to the drilling station and densifying station.

19. A method for manufacturing a seamless duct, said duct having a polymeric foam member having an outer insulating foam layer in communication with a densified inner foam layer surrounding a hollow core, comprising the steps of:
(a) securing the foam member;
(b) heating a probe to a temperature above the glass transition temperature of the foam member;
(c) densifying the inner foam layer by moving the heated probe in one end of the foam member through and out of the opposing end of the foam member thermoforming the densified inner foam layer and the hollow core; and
(d) shaping the outer insulating layer.

20. The method according to claim 19, further comprising the additional step of cutting out a pilot hole in the foam member prior to densifying the inner foam layer, through which the heated probe passes therethrough.

21. The method according to claim 19, further comprising the additional step of densifying a portion of the outer insulating foam layer to form a densified outer foam layer.

22. The method according to claim 19, further comprising the additional step of wrapping an external coating layer around the outer surface of the seamless duct.
